(19) United States
(12) Patent Application Publication
(10) Pub. No.: US 2008/0095573 A1
(43) Pub. Date: Apr. 24, 2008

(54) Joining system for tubular members

(76) Inventors: Frank W. Hewett, Hillsboro, OR (US); David Hewett, Hillsboro, OR (US)

Correspondence Address: KLARQUIST SPARKMAN, LLP, 121 SW SALMON STREET, SUITE 1600, PORTLAND, OR, 97204, US

(21) Appl. No.: 12/001,918

(22) Filed: Dec. 12, 2007

Related U.S. Application Data
(63) Continuation of application No. 10/339,137, filed on Jan. 9, 2003, now abandoned.
Application No. 10/339,137 is a continuation-in-part of application No. 09/877,580, filed on Jun. 6, 2001, now abandoned.
(60) Provisional application No. 60/217,591, filed on Jul. 12, 2000.

(51) Int. Cl. F16B 7/08; F16L 3/02

(52) U.S. Cl. 403/190; 248/74.1

(57) ABSTRACT

A joining system for tubular members having attaching members and two types of stabilizing members. A first type of stabilizing member is used to attach two tubular members at a plurality of angularities and a second type is used to attach two tubular members at a ninety degree angle. One tubular member is attached to another tubular member by a groove in a stabilizing member being positioned against a first tubular member, another groove of the stabilizing member being positioned against a second tubular member at a desired angle. The attaching member is positioned through holes in the tubular members and stabilizing members. The system includes two wing nut wrenches for attaching tubular members to each other. One wing nut wrench can also be used as a petcock wrench. Two jig systems for holding tubular members in place while holes are drilled therethrough are also disclosed, as is a method for joining tubular members.

Applicant hereby claims priority of provisional patent application 60/217,591 filed on Jul. 12, 2000.

This is a continuation-in-part of application Ser. No. 09/877,580 filed Jun. 6, 2001

### BACKGROUND OF THE INVENTION

There are numerous applications for which it would be desirable to have a quick and easy means and system for joining tubular members at a plurality of angularities in a rigid and strong manner. One obvious application for the herein described joining system would be to form the shell for a temporary structure such as a shade tent that can quickly and easily be constructed on a beach. Then, when leaving the beach, the temporary structure could be just as easily broken down and removed. There are a myriad of similar applications, too numerous to list in their entirety, some of which will be described herein by way of example only.

U.S. Pat. No. 229,788 to Winnek discloses a harrow tooth holder for holding the teeth of a harrow in various positions.

U.S. Pat. No. 274,404 to Adler shows a wing nut and petcock wrench that is used to turn a wing nut tightly.

U.S. Design Pat. No. 329,178 to Ackerman discloses a wing nut wrench having a handle portion with grooves.

U.S. Pat. No. 504,717 to Fanckboner discloses an umbrella support that allows an umbrella handle to be angled at various angles.

U.S. Pat. No. 595,196 to Bothwell discloses a display stand that is formed by tubular members that are attached to each other by various tittings.

U.S. Pat. No. 777,037 to Liebau discloses a supporting frame which uses discs to allow the legs to either be locked in operative relation or collapsed in disassembly.

U.S. Pat. No. 1,361,211 to Wilson teaches a wire protector that employs grooved disks to keep wires separate from one another.

U.S. Pat. No. 2,153,547 to Charlop et al. discloses a hammock tent and support that uses disks to provide the same angularity at two or more ends of the tent.

U.S. Pat. No. 3,469,588 to Rainwater discloses an articulated multisection shelter that uses swivel joints.

U.S. Pat. No. 4,066,089 to Rainwater discloses a collapsible shelter structure that has pivoted corner braces.

U.S. Pat. No. 5,546,971 to Leonhardt discloses a foldable shelter with struts that disconnect when not in use.

U.S. Pat. No. 5,584,311 to Schaefer teaches a self supported tent frame coupler that retains support poles at a preferred angular orientation.

U.S. Pat. No. 5,791,363 to Moses discloses a knockdown portable shelter that forms a particular type of framework.

U.S. Pat. No. 5,908,207 to Wilson discloses a book holder with a stand that is easily assembled by a screw and a wing nut.

### SUMMARY OF THE INVENTION

In order to overcome problems inherent in the prior art, there has been devised by the present invention, a new and novel joining system for joining a plurality of tubular members to each other at a plurality of angles to thereby form the shell for a structure or other framework. The joining system of the present invention comprises in general, tubular members, two types of stabilizing members and attaching members. Each attaching member generally comprises a nut and bolt configuration but other such configurations are within the spirit and scope of the invention. There are two different types of stabilizing members in the present joining system for tubular members. One type of stabilizing member allows tubular members to be attached to each other at a plurality of angularities. The second type of stabilizing member serves to allow tubular members to be attached to each other at a ninety degree angle. Both types of stabilizing members provide a solid and strong connection formed at the connection of the tubular members. The system also includes two wing nut wrenches for attaching tubular members to one another. A variation of one wing nut wrench is used as a petcock wrench in another application. Two jig systems are also disclosed for holding tubular members in place while holes are drilled through them in order to attach tubular members at a variety of angularities.

### BRIEF DESCRIPTION OF THE DRAWINGS

FIG. 1A is an exploded view of the basic elements used in the present joining system for tubular members wherein a first type of stabilizing member is used to provide a plurality of angular relationships between two tubular members.

FIG. 1B is an exploded view of the basic elements used in the present joining system for tubular members wherein a second type of stabilizing member is used to provide a plurality of angular relationships between two tubular members.

FIG. 2 is a perspective view of a first wing nut wrench used in the present tubular member joining system.

FIG. 2A is a perspective view of a first petcock wrench used to tighten a thumbscrew in one jig system of the present invention and as it is used in a different application. FIG. 2A shows a variation of the first wing nut wrench of FIG. 2 used for tightening or loosening a thumbscrew and the unrelated purpose of tightening or loosening a petcock.

FIG. 2B is a perspective view showing a standard petcock and showing the pieces that the petcock wrench of FIG. 2A would come into contact with if the petcock wrench of FIG. 2A is used for the unrelated purpose of tightening or loosening a petcock.

FIG. 2C is a perspective view of the wing nut wrench of FIG. 2 wherein a plurality of wing nut wrenches have to varying sizes and varying size bolt engaging holes therein.

FIG. 2C also represents a nested version of FIG. 2A which would have varying sizes and varying sizes of petcock engaging slots therein FIG. 3 is a perspective view of a second wing nut and petcock wrench used in the present tubular joining system.

FIG. 4 is a perspective view of a jig system provided with and part of the present invention that allows a tubular member to be held in place in the proper position while holes are cut through the tubular member at a desired angularity and in a desired position.

FIG. 5 is a perspective view of a second jig system provided with and part of the present invention that allows two tubular members to be held in place in the proper position while a hole is cut through both tubular members at the same time. The jig system as shown in FIG. 5 is most often used when the joining system is being set up and particular holes are needed but unavailable, in a particular piece of tubing.

FIG. 6 is a perspective view of a first application of the present tubular member joining system.

FIG. 6A is an enlargement of the circled joining configuration as shown in FIG. 6.

FIG. 7 is a perspective view of a second application of the present tubular member joining system.

FIG. 7A is an enlargement of the circled joining configuration as shown in FIG. 7.

FIG. 8 is a perspective view of a third application of the present tubular member joining system.

FIG. 8A is an enlargement of the circled joining configuration as shown in FIG. 8.

FIG. 9 is a perspective view of a fourth application of the present tubular member joining system.

FIG. 9A is an enlargement of the circled joining configuration as shown in FIG. 9.

FIG. 10 is an exploded view of the downspout area of the fourth application of the present tubular member joining system whereby water is removed from the top of the structure as seen in FIG. 9.

FIG. 11 is a perspective view of the fifth application of the present tubular member joining system.

FIG. 11A is an enlargement of the circled joining configuration as shown in FIG. 11.

### DETAILED DESCRIPTION OF THE PREFERRED EMBODIMENTS

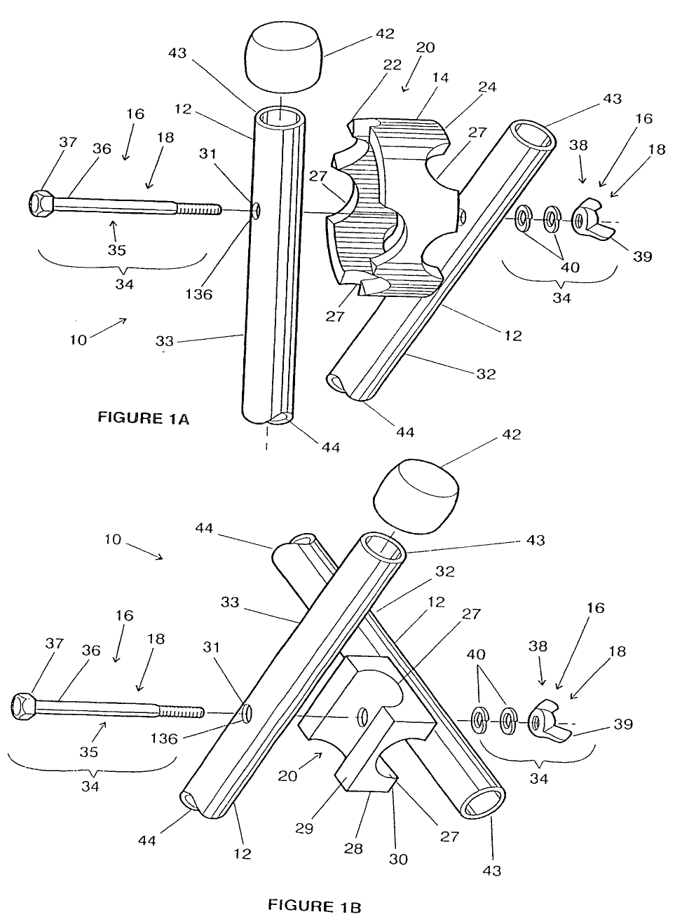

Referring now to the drawings in general, and in particular to FIGS. 1A and 1B, there are shown exploded views of the basic elements used in the present joining system for tubular members. It is to be understood that the herein described joining system for tubular members has many applications and the applications described and shown herein should be viewed as examples only and the present invention should not be limited by such examples. The present invention should also not be limited to the sizes of the parts described. In FIG. 1A there are seen the basic elements necessary for the joining of tubular members of the present invention, wherein a first type of stabilizing member is used to provide a plurality of angular relationships between two tubular members. The system is shown generally by the number 10. The system includes tubular members 12 that are joined to other tubular members 12 by means of a stabilizing member 14 or 28, as seen in FIG. 1B, and an attaching means, shown generally by the number 16, and in the form of an attaching member 18. The first type of stabilizing member 14, in the form of a stabilizer 20, is generally a ring like shape. The stabilizing member 14 has at a top surface 22 and the bottom surface 24 of its ring like shape, a plurality of grooves 27. These grooves 27 are of a size adapted to fit and hold a tubular member 12 so that two tubular members 12 can be attached to each other at twenty two and one half or forty five degree angle. Other angles, of course, would be within the spirit and scope of the invention.

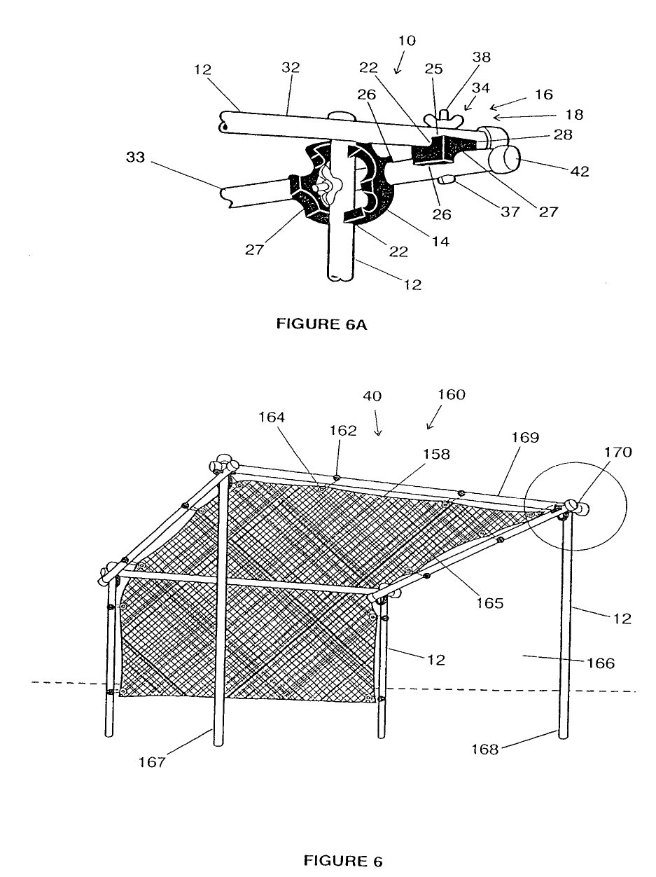

Referring now to FIG. 1B there are also seen the basic elements necessary for the joining system for tubular members of the present invention, wherein a second type of stabilizing member is used to provide a ninety degree connection between two tubular members. The second type of stabilizing member 28, also in the form of a stabilizer 20, is generally a square like shape. In a manner similar to the first type of stabilizing member 14, the second type of stabilizing member 28 has a top surface 29 and a bottom surface 30. The top surface 29 and the bottom surface 30 of the second type of stabilizing member 28 each has a groove 27 identical to the grooves 27 in the first type of stabilizing member 14. There is however, only a single groove 27 in each of the top 29 and bottom 30 surfaces of the second type of stabilizing member 28, with the groove 27 in the top surface 29 in ninety degree relationship, or perpendicular, to the groove 27 in the bottom surface 30 of the second type of stabilizing member 28. The second type of stabilizing member 28 is thereby used to attach two tubular members 12 to each other at a ninety degree angle. There are holes 31 in the tubular members 12 at appropriate intervals for receiving an attaching member 18 as will be described hereinafter. In practice, as seen in FIGS. 6A, 7A, 8A, 9A and 11A, a first tubular member 32 is placed in a desired groove 27 on the top surface 22 or bottom surface 24 of the first type of stabilizing member 14, or in a desired groove 27 on the top surface 29 or bottom surface 30 of the second type of stabilizing member 28, as seen in FIGS. 1A and 1B. A second tubular member 33 is then placed in a groove 27 on the surface 22 or 24 of the first type of stabilizing member 14, or in a groove 27 on the surface 29 or 30 of the second type of stabilizing member 28 that is opposite the first tubular member 32 at the desired angle relative to the first tubular member 32, with holes 31 in the tubular members 12 lined up. So, for example, if the first tubular member 32 is placed in a groove 27 on the top surface 22 or 29 of the stabilizing member 14 or 28, then the second tubular member 33 is placed in a groove 27 on the bottom surface 24 or 30 of the stabilizing member 14 or 28 and vice versa. The attaching member 18 comprises generally a bolt and a wing nut combination 34, but other attaching members 18 would be within the spirit and scope of the invention. The bolt portion 35 of the bolt and wing nut combination 34 includes a bolt 36, having a bolt head 37, the bolt 36 is positioned through the lined up holes 31 in the tubular members 12. The wing nut portion 38 of the bolt and wing nut combination 34 includes a wing nut 39 and several washers 40. The wing nut portion 38 of the bolt and wing nut combination 34 is tightened down, thereby connecting the two tubular members 32 and 33 at the desired angular relationship, as seen in FIGS. 6A, 7A, 8A, 9A and 11A. The two types of stabilizing members 14 ad 28 then serve two purposes. First, they support a first tubular member 32 at a preferred angularity to a second tubular member 33 and second, they support and form a brace for the resultant framework such that no further support, such as a diagonal brace is required for a structure or framework 41, as seen in FIGS. 6, 7, 8, 9 and 11. The tubular members 12 each have end caps 42, so that sharp ends 43 and 44 of the tubular members 12 do not remain exposed. The present system 10 for joining tubular members 12 facilitates the quick and simple assembly and disassembly of innumerable configurations of structures or frameworks 41. The resulting framework 41 is flexible in the size of pieces used and the number of pieces used and accommodates many applications that require that the structure or framework have strength.

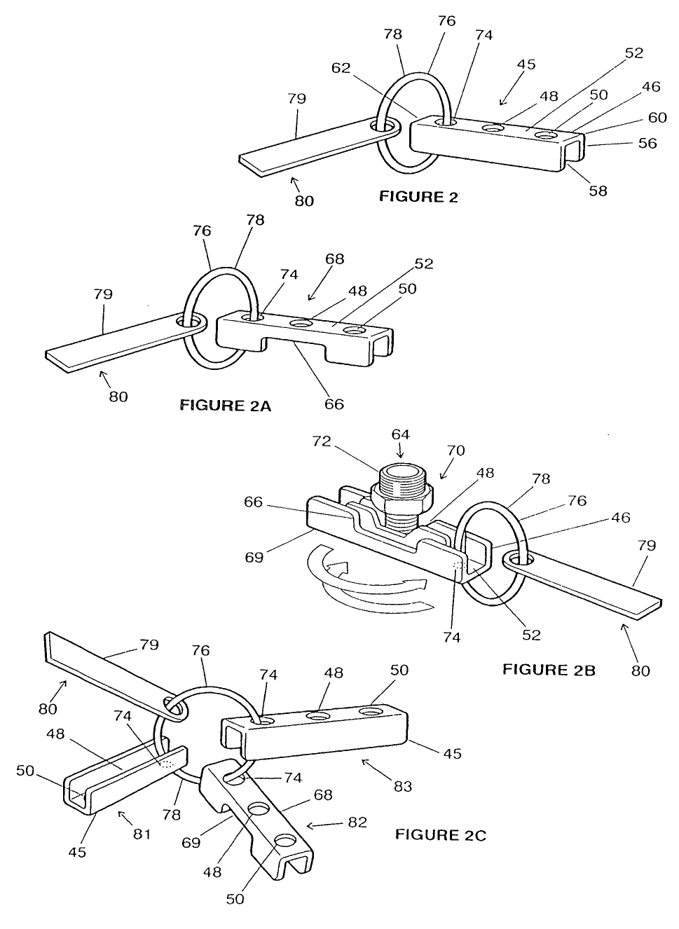

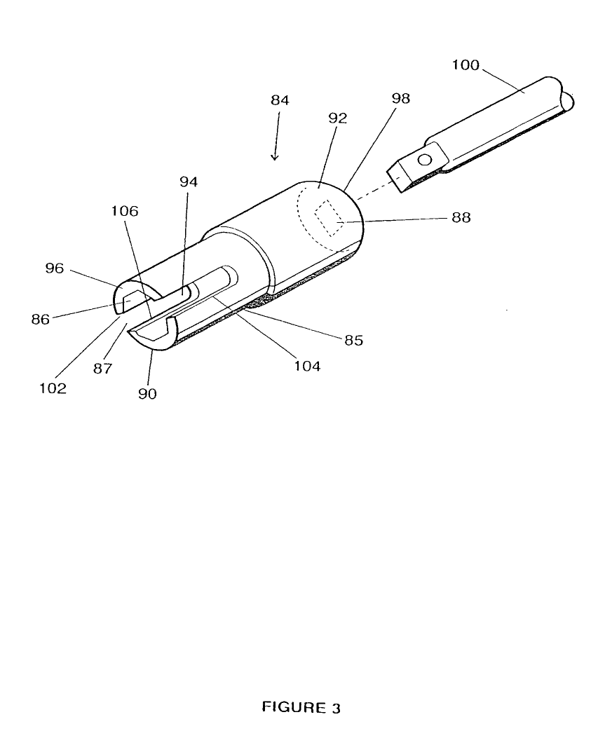

Referring now to FIG. 2 of the drawings there is shown a further element of the present joining system 10, a first wing nut wrench shown generally by the number 45. The first wing nut wrench 45 is substantially a piece of metal channeling 46 having at least two holes 48 and 50 through the lower surface 52 of the channel 46. The first hole 48 is substantially in the middle of the lower surface 52 of the channel 46, and is adapted to fit the bolt portion 35 of a bolt and wing nut combination 34, as seen in FIGS. 1A and 1B. In practice, the channel 46 is positioned atop the bolt portion 35 of the bolt and wing nut combination 34 and the bolt portion 35 of the bolt and wing nut combination 34 is positioned through the first hole 48 in the channel 46. The wings 54 of the wing nut 39 of the bolt and wing nut combination 34, as seen in FIGS. 1A and 1B, fit within the sides 56 and 58 of the channel 46 to provide the leverage needed to turn the wing nut 39. The channel 46 is then turned to move the wing nut 39 of the bolt and wing nut combination 34 relative to the bolt portion 35 of the bolt and wing nut combination 34, either loosening or tightening the wing nut 39. A second hole 50 is positioned also in the lower surface 52 of the channel 46 substantially at the first 60 or second 62 end of the lower surface 52 of the channel 46. The purpose of this second hole 50 is to allow the second hole 50 to be positioned over the bolt portion 35 of a bolt and wing nut combination 34 when the wing nut 39 is in close quarters, so that it is not required that the wing nut wrench 44 have a large space to be turned.

Referring now to FIG. 2A there is shown a perspective view of a first petcock wrench as used to tighten a thumbscrew as will be described hereinafter and in a different application. If the wing nut wrench 45 of the FIG. 2 is used for the unrelated purpose of opening a petcock 64, as seen in FIG. 2B, a notch 66 is formed in the wing nut wrench 45 thereby making the wrench a petcock wrench 68. The notch 66 in the petcock wrench 68 is adapted to fit around an indented screw and nut combination 70 in a petcock 64, as seen in FIG. 2B. The hole 48 in the petcock wrench 68 through which the screw portion 72 of the screw and nut combination 70 of the petcock 64, as seen in FIG. 2B, would allow fluid or air to pass easily from the petcock 64. A third hole 74 is also positioned through the lower surface 52 of the channel 46. Through the third hole 74 there is threaded a loop 76 of cording 78 or other attaching material, and attached also on the loop 76 is a tag 79. The tag 79 serves at least two purposes: first to identify the manufacturer, indicia can be added to the tag 79; and second to provide a hanging means 80 by which the wing nut wrench 45 or the petcock wrench 68 can be hung on a wall or equipment to later be found easily.

Referring now to FIG. 2C of the drawings there is shown a perspective view of the wrenches 45 of FIGS. 2 and 69 of FIG. 2A wherein there is a plurality of wing nut wrenches 45 that have varying size bolt engaging holes 48 therein. Thus, the differing sizes of wing nut wrench 45 can serve different functions in different applications. It can be seen from FIG. 2C that it can also represent a nested version of FIG. 2A wherein the petcock wrenches 68 can also be nested for varying size and varying size of petcock engaging slots 69. In the preferred embodiment of FIG. 2C, the smallest wing nut wrench 81 may be used to turn thumb screws or small wing nuts, the medium sized wing nut wrench 82 may be used to turn petcocks, and the largest wing nut wrench 83 may be used to turn larger wing nuts.

Referring now to FIG. 3 of the drawings there is shown a perspective view of a second type of wing nut wrench, shown generally by the number 84, which is used in the present system. The second wing nut wrench 84 is a cylindrical member 85, a hollow cylindrical tube 86 having holes 87 and 88 at both ends 90 and 92. The wing nut wrench 84 is substantially a deep socket with a slot 94 across the hex end 96. The end 98 opposite of the hex end 96 of the tube 86 has a square hole 88 as would be found in a typical socket wrench, the square hole 88 being compatible to receive the handle 100 of a socket wrench, as seen in FIG. 3. The slot 94 at the hex end 96 of the tube 86 with the hex opening or hole 87 has substantially across the diameter 102 of the hex opening or hole 87 two notches 104 and 106 forming the slot 94 for receiving the wing nut portion 38 of the bolt and wing nut combination 34, as seen in FIGS. 1A and 1B. In practice, the cylindrical tube 84 is inserted atop the wing nut portion 38 of a bolt and wing nut combination 34, as seen in FIGS. 1A and 1B. Upon turning the tube 84, the wing nut 39 is then tightened or loosened from the bolt portion 35 of the bolt and wing nut combination 34, depending on which way the tube 86 is turned.

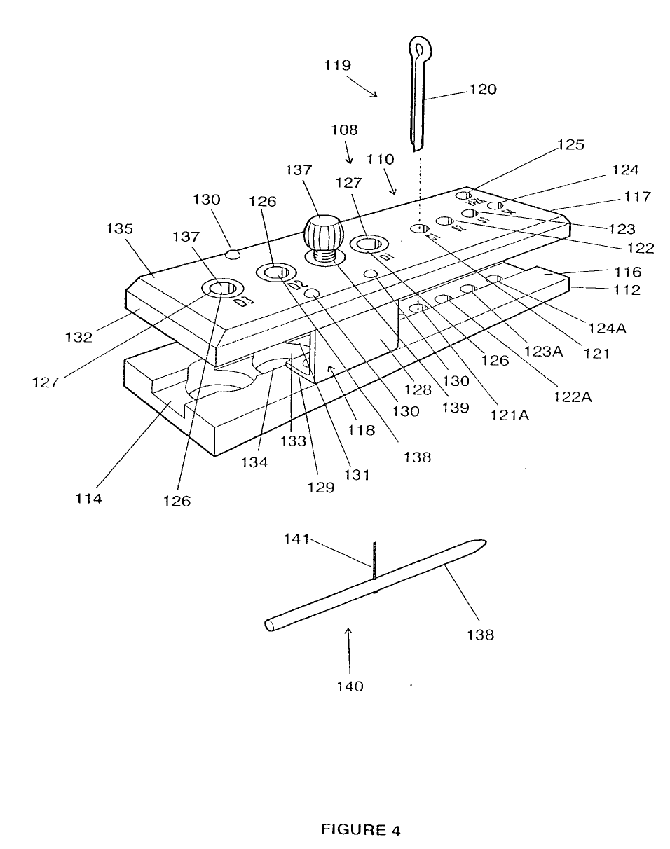

As seen in FIG. 4, also provided in the present system for joining tubular members 10 is a first jig system 108 for holding a tubular member 12 in place while it has holes 31 placed therein at various desired angles, as seen in FIGS. 1A and 1B. The first jig system 108 of the present invention is shown most clearly in FIG. 4 and comprises in general, a device 110 having a lower plate 112 with a tubular member 12 receiving groove 114 routed in the upper surface 116 of the lower plate 112. A stop 119, in the form of a pin 120, is provided to be positioned through an upper plate 117 and into the lower plate 112 such that as a tubular member 12, as seen in FIGS. 1A and 1B, is positioned in the groove 114 within the device 110, the tubular member 12 is forced to stop at a location corresponding to the position where it is appropriate to drill a hole through the tubular member 12. The upper plate 111 is attached to the lower plate 112 by an attaching member 118. In the example shown in FIG. 4, there are four holes marked S1 121, S2 122, S3 123 and S4 124 in the upper plate 117 that will hold the stop 119 in the form of a pin 120. Each of the stop holes 121, 122, 123, and 124 in the upper plate 117 has a corresponding hole 121A, 122A. 123A, and 124A in the groove 114 in the lower plate 112 so the stop 119 or pin 120 can be positioned all the way through the jig system 108 and locked in place. There could be more or less of these stop holes 121, 122, 123 or 124. Thus, in the example of FIG. 4, there are four locations where a tubular member 12, as seen in FIGS. 1A and 1B could be stopped by positioning the pin 120 in a corresponding location. The pin 120 thereby sets the distance from the end 43 or 44 of the tubular member 12 to the appropriate hole 31 or holes to be drilled. A fifth hole 125 is generally used to park the pin 120 when it is not in use. An example of when the fifth hole 125 would be used is when a hole is to be drilled in a location of a tubular member 12 that is beyond the length of the device 110. The upper plate 117 also has a plurality of drill holes 126 therethrough for holding a drill bit in position when holes 31 are being drilled in a tubular member 12, as seen in FIGS. 1A and 1B. Each of the drill holes 126 has a bushing 127 within for providing durability with repeated long time use of the device 110. In practice, a tubular member 12 is inserted in the jig device 110 and stopped by the stop 119. There is a first u-shaped member 128, one of which is seen in FIG. 4 and a second identical u-shaped member (not seen) is positioned across from the first u-shaped member 128 in FIG. 4. The generally u-shaped members 128 form the attaching member 118 that holds the upper plate 117 and the lower plate 112 together, the generally u-shaped members 128 have a first horizontal portion 129 that ends at the groove 114 in the upper surface 116 of the lower plate 112. The first horizontal portion 129 attaches the u-shaped member 128 to the upper surface 116 of the lower plate 112 by means of rivets 130. A second horizontal portion 131 attaches the u-shaped member 128 to the lower surface 132 of the upper plate 117, also by means of rivets 130. Thus, a channel 133 is formed where the u-shaped members 128 are positioned to the edge 134 of the groove 114 in the lower plate 112. The channel 133 and the groove 114 ensure that a tubular member 12 will be directed straight within the device 110 of the jig system 108 and will not come out of the groove 114. A hole 31 is formed through the tubular member 12, as seen in FIGS. 1A and 1B, by placing a drill bit through the appropriate drill hole 126 in the upper surface 135 of the upper plate 117. In order to drill a hole 31 in a specific place, the user should first determine which stop hole 121, 122, 123 or 124 and which corresponding drill hole 126 are appropriate to use. The combination of the stop pin location and drill hole 126 to be used will depend on the specific application. Instructions for using various locations and drill holes 126 are provided with the joining system for tubular members 10, as seen in FIGS. 1A and 1B. When it is required that a second hole be drilled that is at a right angle to a first hole 136, as seen in FIG. 1B, the thumbscrew 137 is loosened and the tubular member 12, as seen in FIGS. 1A and 1B, is rotated approximately ninety degrees. Any appropriate item such as the stick 138 is placed through the first hole 136 just drilled in the tubular member 12, as described above, and as seen in FIG. 1B. The tubular member 12 is then rotated so that the stick 138 is horizontal and the tubular member 12 is snug to the stop 119. The stick 138 is therefore used as an indicator 140 or flag to indicate a parallel or perpendicular relative position of two holes 31. When drilling a second hole (not seen) in the tubular member 12, placing the stick 138 in the first hole 136, as seen in FIG. 1A or 1B, indicates parallelness, the stick pin 141 prevents the stick 138 from falling through the hole 136. The thumbscrew 137 is then tightened to secure the tubular member 12 and the hole 31 is drilled through the second drill hole (not seen). When it is required that holes 31 be drilled on each end 43 and 44 of a tubular member 12, as seen in FIGS. 1A and 1B, and the holes 31 are required to be parallel to each other, after a hole or holes 31 are drilled in a first end 43 as desired, a second undrilled end 44 of a tubular member is then reinserted into the jig system 108. The stick 138 is then inserted into the previously drilled hole 136, as seen in FIGS. 1A and 1B. The tubular member 12 is then adjusted so that the stick 138 is positioned vertically to the tubular member 12. The thumbscrew 137 is then tightened to secure the tubular member 12 and the hole 31 is drilled. The thumbscrew 137 is tightened down by the smallest wrench 45 as shown in FIGS. 2 and 2C. The thumbscrew 137 can be loosened back up but still kept in its location at hole 139, so it will not be lost when not in use. The stick 138 can also be used as a plug to measure an equal distance at both ends 43 and 44 of a tubular member 12, as seen in FIGS. 6, 7, 8, and 9. The appropriate hole 126 to use in the upper plate 117 to achieve a ninety degree angle between two holes 31 in a tubular member 12, for example, can also be identified for the user by color coding of the holes 126 in the upper plate 120, or other suitable means.

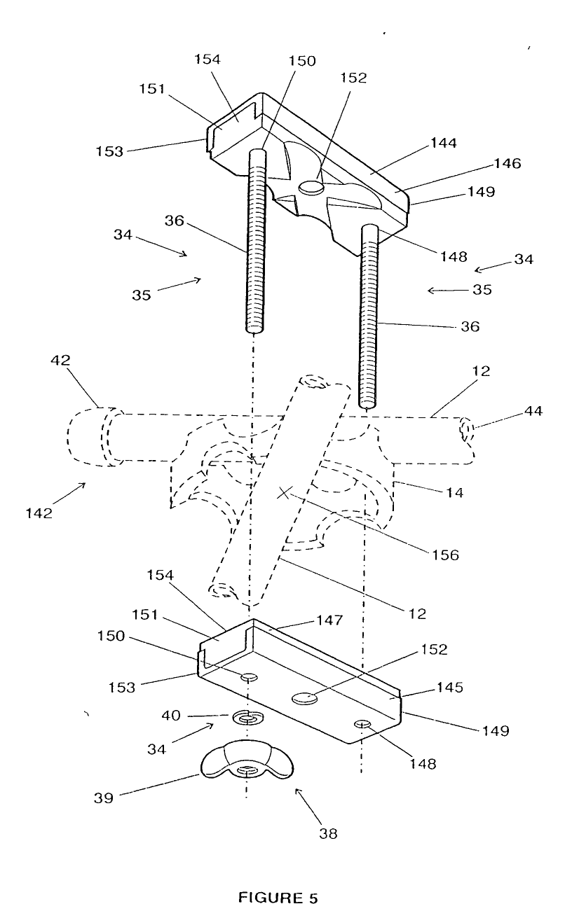

Referring now to FIG. 5 of the drawings there is shown a perspective view of a second jig system 142 provided with and part of the present invention. The second jig system 142 is most often used to hold a tubular member 12 in place in a fixed position while a hole 31 is cut through the tubular member 12, while the joining system 10, as seen in FIGS. 1A and 1B, is being set up. The second jig system 142 is generally used with the joining system 10 being partially put together and wherein a hole 31 in a tubular member 12 is necessary, but unavailable, for completing a particular structure or framework 41. In FIG. 5, it can be seen that the second jig system 142 comprises an upper 144 and lower plate 145 in the form of two generally rectangular members 146 and 147, each having a plurality of holes 148 therethrough. Each rectangular member 146 and 147 has at least one hole 148 generally at a first end 149 and at least a second hole 150 generally at a second end 151. Each rectangular member 146 and 147 also has a generally central hole 152 and generally includes a metal unshaped portion 153 and a high-density polyethylene t-shaped portion 154, which fits inside the u-shaped portion 153. In practice, a bolt portion 35 of a bolt and wing nut combination 34, as seen in FIGS. 1A and 1B, is positioned through the hole 148 in the first end 149 of a first rectangular member 146 and through the corresponding hole 148 in the first end 149 of a second rectangular member 147. The wing nut portion 38 of a bolt and wing nut combination 34 is screwed down in a conventional manner to position the second jig system 142 around two attached tubular members 12. The second end 151 of the first 146 and second rectangular members 147 are attached to each other as the first ends 149 were. Thus, with the tubular members 12 and the second jig system 142 attached as shown in FIG. 5, a hole can be drilled through both of the tubular members 12 at position 156, by placing a drill bit in the centralized hole 152 in the rectangular members 146 and 147 and drilling into the tubular member 12.

The following examples show some ways in which the present joining system for tubular members 10 can be used. They are meant as examples only and various changes to the size, arrangements of various parts are within the spirit and scope of the invention. For example, with slight changes to the sizes of parts, the present joining system for tubular members 10 can be used to form various configurations of scaffolding or laddering.

Referring now to FIG. 6 of the drawings, there is shown one application of the present joining system for tubular members 10. FIG. 6 is a perspective view of a configuration of the present system used as a protective structure from wind or sun having a slightly slanted roof 158 so as not to hold rain on top. The angle used to connect two tubular members 12 together to form the slanted roof 158 may be twenty two and one half degrees, or other desired angle, so the first type of stabilizing member 14 is used to form these connections between two tubular members 12. The slanted roof 158 is attached to the framework 160 formed by the tubular members 12 by means of stretch cords 162 through grommets 164 in a tarpaulin 165 in a known manner. The front opening 166 of the protective structure as seen in FIG. 6, is formed by the two front tubular members 167 and 168 being attached at right angles to the front cross tubular member 169 at the front of the slanted roof 158 and having the second type of stabilizing member 28 in between the tubular members 12 since right angle connections are formed at the front opening 166 of the structure 160.

FIG. 6A is an enlargement of the circled area in FIG. 6 showing an enlargement of the parts forming the appropriate angle 170 in FIG. 6. FIG. 6A shows more clearly the arrangement of the tubular members 12, stabilizing members 14 and 28, attaching means 16 in the form of an attaching member 18 which is a bolt and wing nut combination 34. It can be seen in FIG. 6A that the ninety degree angle connection uses the second type of stabilizing member 28 between tubular members 12 and another angular connection other than ninety degrees uses the first type of stabilizing member 14.

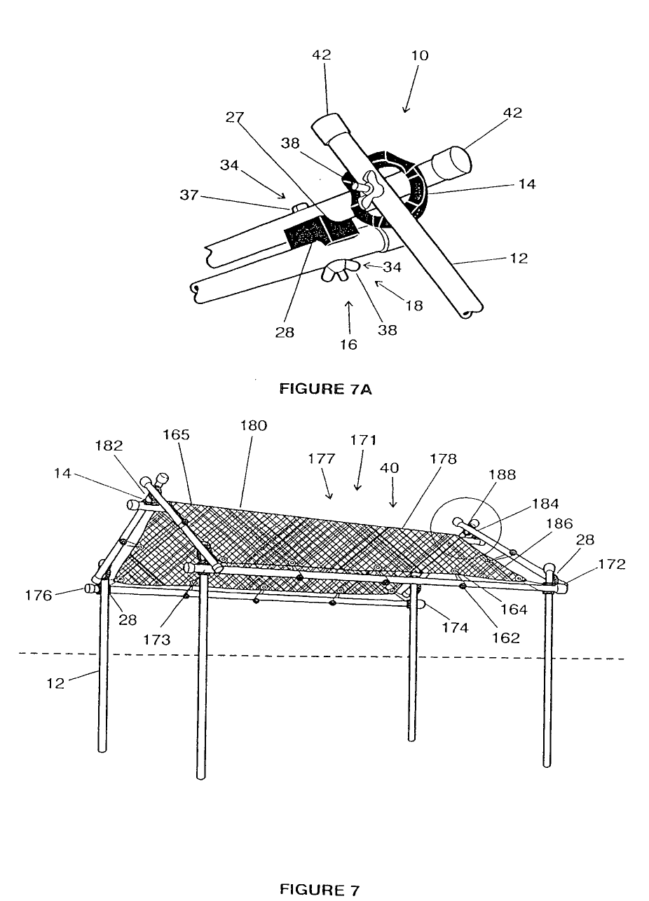

Referring now to FIG. 7 of the drawings there is shown a perspective view of a second application of the present tubular member joining system 10 wherein the system is used to provide shade or other protection, such as a temporary carport 171 for a car joining occurs at four locations 172, 173, 174, and 176 so as to form a two-sided structure or framework 177 having a partially slanted roof 178 on top 180 of the framework 177. Then, across the top 180 of the framework 177, a second set of joining 182 and 184 occurs at an angle to form the triangular section 186 of the roof 178. In FIG. 7 also it can be seen that at the right angle connections 172, 173, 174, and 176, the second type of stabilizing member 28 is positioned between two joined tubular members 12, and at angles other than ninety degrees, the first type of stabilizing member 14 is positioned between two joined tubular members 12. The roof 178 of FIG. 7 is attached to the framework 177 formed by the tubular members 12 by means of stretch cords 162 through grommets 164 in a tarpaulin 165 in a known manner similar to FIG. 6.

FIG. 7A is an enlargement of the circled area in FIG. 7, similar to FIG. 6A, showing an enlargement of the parts forming the appropriate angle 188 in FIG. 7. FIG. 7A shows more clearly the arrangement of the tubular members 12, stabilizing members 14 and 28, attaching means 16 in the form of an attaching member 18 which is a boll and wing nut combination 34.

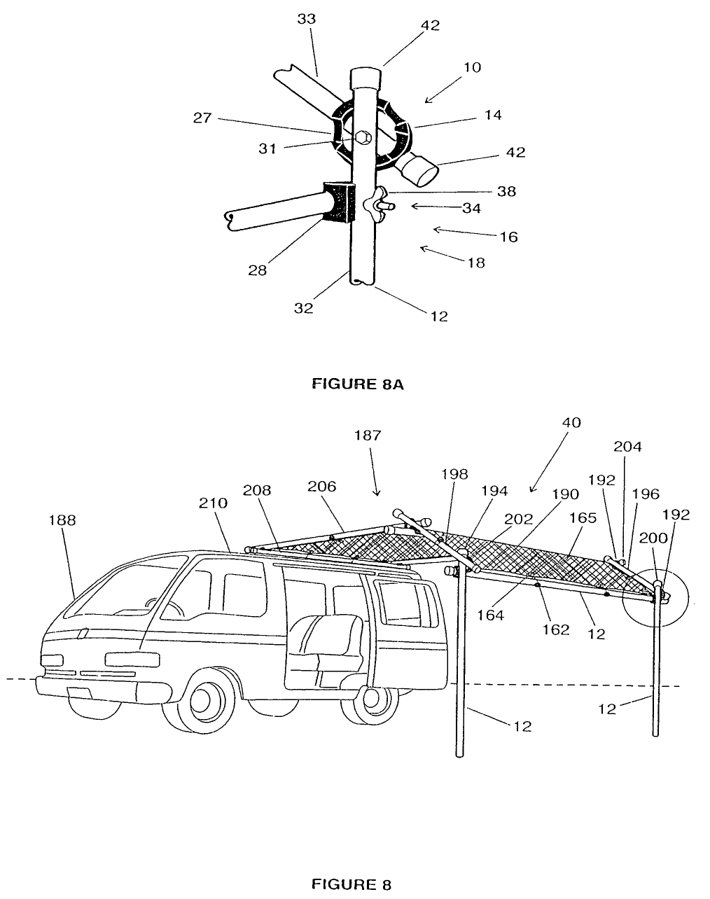

Referring now to FIG. 8 of the drawings there is shown a perspective view of a third application of the present tubular member joining system 10 wherein the system is used to provide a temporary protective structure or framework 187 with a portion positioned directly atop a van 188 or other vehicle. The application as shown in FIG. 8 using the present tubular member joining system 10 for a temporary structure or framework 187 can be used, for example, by a van owner who uses his vehicle to transport things to sell, such as a local fruit vendor. Another use for the application shown in FIG. 8 would be a camper who sets up a temporary shade for a patio when parked at a camping site. The roof 190 of FIG. 8 is attached to the framework 187 formed by the tubular members 12 by means of stretch cords 162 through grommets 164 in a tarpaulin 165 in a known manner similar to FIGS. 6 and 7. FIG. 8A is an enlargement of the circled area in FIG. 8, similar to FIGS. 6A and 7A, showing an enlargement of the parts forming the appropriate angle 192 in FIG. 8. FIG. 8A shows more clearly the arrangement of the tubular members 12, stabilizing members 14 and 28, attaching means 16 in the form of an attaching member 18 which is a bolt and wing nut combination 34.

To form the configuration as shown in FIG. 8, two vertically placed tubular members 12 of appropriate height approximating the height of a van 188 are each attached to a horizontally placed tubular member 12, such that the vertically placed tubular members 12 are at a ninety degree angle to the horizontally placed tubular member 12. One of two of the second type of stabilizing members 28 are each positioned between the tubular members 12 with holes 31 and grooves 27 are appropriately lined up as seen in FIG. 8A. Two more tubular members 196 and 198 are then attached to the top end 194 of the vertically positioned tubular members 200 and 202 and the tubular members 12 are connected to each other as described hereinbefore with stabilizing members 14 or 28 positioned sandwiched between, since the tubular members 196 and 198 are attached to the vertically positioned tubular members 200 and 202 at angles other than ninety degrees. Two further tubular members 204 and 206 are then attached to the tubular members 196 and 198 extending from the vertically positioned members 200 and 202, such that a second horizontally positioned tubular member 208 can be positioned between the last described tubular members 204 and 206 to provide a framework 187 as seen in FIG. 8. The second horizontally positioned tubular member 208 would be placed on the top 210 of a van 188 or other vehicle to make the framework 187 as shown in FIG. 8.

FIG. 8A is similar to FIGS. 6A and 7A, an enlargement of the circled area in FIG. 8, showing an enlargement of the parts forming the appropriate angle 192 in FIG. 8. FIG. 8A shows more clearly the arrangement of the tubular members 12, stabilizing members 14 and 28, attaching means 16 in the form of an attaching member 18 which is a bolt and wing nut combination 34.

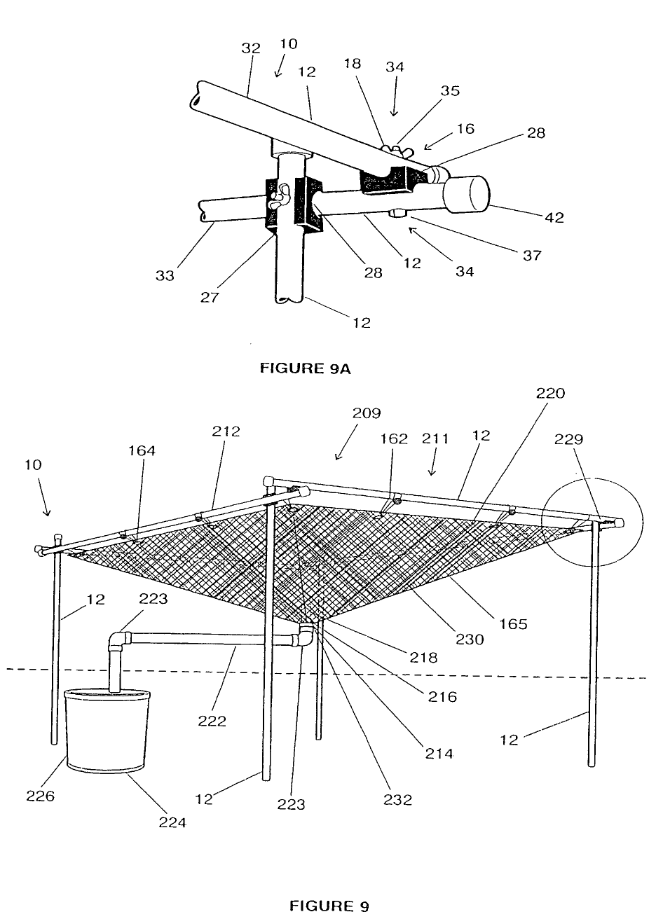

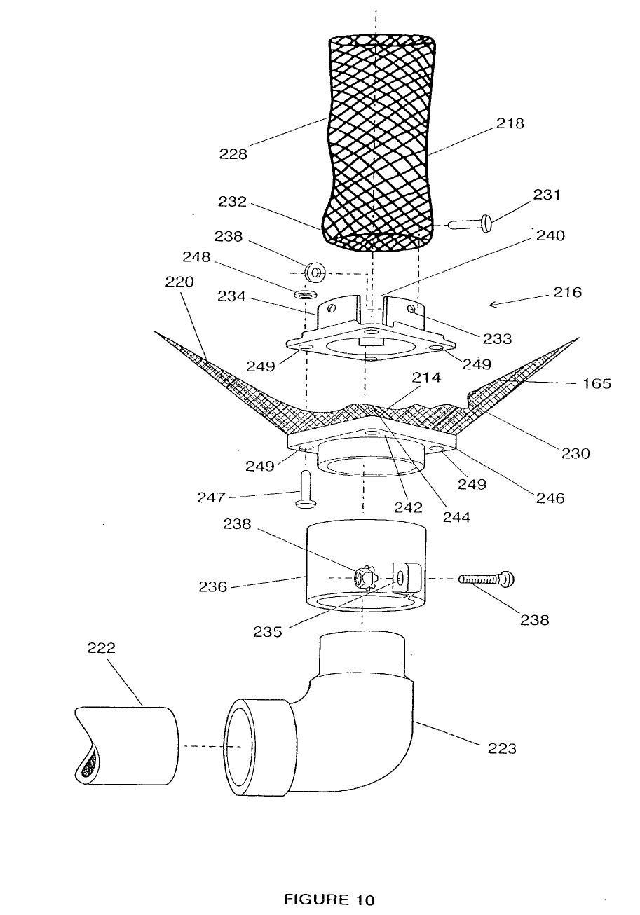

Referring now to FIG. 9 there is shown a perspective view of a fourth application of the present tubular member joining system 10 wherein the system is used to provide a rain water collection system 209. In FIG. 9 it can be seen that tubular members 12 of approximately the same height are attached to each other at ninety degree angles to therefore form a generally boxed shaped structure 211. Since the tubular members 12 are joined at ninety degree angles, the second type of stabilizing member 28 is positioned between two connected tubular members 12. The boxed shaped structure 211 can easily have a tarpaulin 165 positioned loosely across its top 212 and attached with stretch cords 162 or other means positioned through a grommet 164 in the tarpaulin 165 in a known manner. If the tarpaulin 165 is slightly larger than the top 212 of the box shaped structure 211, the tarpaulin 165 will bow or sag in its central portion 214, thereby generally forming an upside down umbrella sort of configuration. Attached generally in the central portion 214 of the tarpaulin 165 is positioned a downspout 216. A mesh portion 218 of the downspout 216 protrudes above the upper surface 220 of the tarpaulin 165 and serves to keep leaves from entering the downspout 216 area. As rain falls it is directed onto the upper surface 220 of the tarpaulin 165 and by natural flow toward the naturally occurring cavity of the central portion 214 of the tarpaulin 165 and down the downspout 216 into piping 222 and elbow joints 223 to be carried also by natural flow into a holding device 224 such as a bucket 226 or other water holding container. The mesh portion 218 of the downspout 216 is formed by flexible plastic that is collapsible for packing and moving the rain collection system 209. The mesh portion 218 of the downspout 216 is attached to the solid piping 222 below the lower surface 230 of the tarpaulin 165 by means of screws 231 pushed through the lower end 232 of the mesh portion 218 and into a hole 233 in a fitting 234, as seen most clearly in FIG. 10. A hole 235 that corresponds to hole 233 on the fitting 234 is positioned through a coupling 236 for an elbow joint 223, as seen most clearly in FIG. 10. The screw 231 is then secured with a bolt 238 within the coupling 236, as seen also in FIG. 10.

FIG. 9A is an enlargement of the circled area in FIG. 9, similar to FIGS. 6A, 7A and 8A, showing an enlargement of the parts forming the appropriate angle 229 in FIG. 9. FIG. 9A shows more clearly the arrangement of the tubular members 12, stabilizing members 28, attaching means 16 in the form of an attaching member 18 which is a bolt and wing nut combination 34. Since all the angles of connection for tubular members 12 are ninety degrees in FIG. 9, only the second type of stabilizing member 28 is used in the example of FIG. 9.

Referring now to FIG. 10 of the drawings, there is shown an exploded view of the downspout 216 area of the fourth application of the present tubular member joining system 10 whereby water is removed from the structure 211 seen in FIG. 9. FIG. 10 shows in more detail the downspout 216 area of the application shown in FIG. 9. The flexible plastic mesh 228 forms the caged portion 218 of the downspout 216. The cylindrical plastic mesh 228 is help atop the fitting 234 positioned above the upper surface 220 of the tarpaulin 165 by means of the screws 231 and a bolt 238, as seen in FIG. 10. The fitting 234 is standard plumbing type fitting that has notches 240 to provide flow of water from the lowest level 242 of the cavity 244 at the central portion 214 of the tarpaulin 165, as seen in FIGS. 9 and 10. Another screw 231 fits through the upper fitting 234 above the upper surface 220 of the tarpaulin 165 and a lower fitting 246 below the lower surface 230 of the tarpaulin 165 as seen in FIGS. 9 and 10. A screw 247 and a nut 248 are positioned through a series of mating holes 249 in the upper fitting 234 and the lower fitting 246, and attaches the upper fitting 234 to the lower fitting 246. The lower fitting 246 fits within a combination coupling and clamp 236 positioned over the elbow joint 223, the elbow joint 223 being connected to conventional plumbing piping 222. The combination coupling and clamp 236 allows the elbow joint 223 to be turned in any direction.

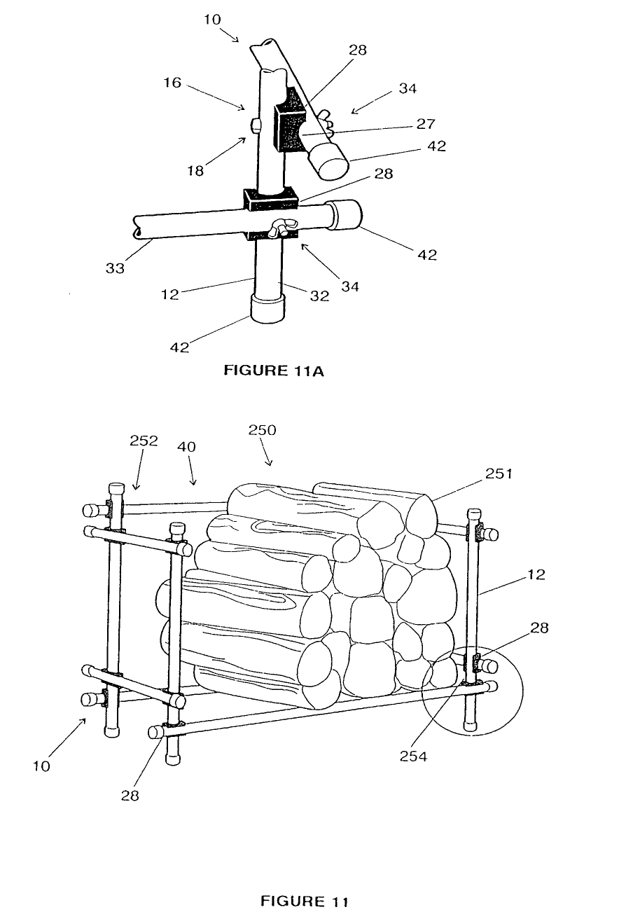

Referring now to FIG. 11 of the drawings, there is shown a perspective view of a fifth application of the present tubular member joining system 10 wherein the tubular members 12 are joined to form generally an open sided, open topped rectangular box shape 250 that holds firewood 251. The shape 250 of FIG. 11, can, of course, be formed in any practical dimensions. In FIG. 11 also, since the tubular members 12 are joined at ninety degree angles, the second type of stabilizing member 28 is positioned between two connected tubular members 12. Because of the increased stability afforded to the framework 252 by the stabilizing members 28, a heavy load of firewood 251 can be held.

FIG. 11A is an enlargement of the circled area in FIG. 11, similar to FIGS. 6A, 7A, 8A, 9A, showing an enlargement of the parts forming the appropriate angle 254 in FIG. 11. FIG. 11A shows more clearly the arrangement of the tubular members 12, stabilizing members 28, attaching means 16 in the form of an attaching member 18 which is a bolt and wing nut combination 34.

It can be seen from the above described examples that there can be achieved by the present joining system for tubular members a multiplicity of angularities and combined angularities can be juxtaposed. Any proposed angularity or combination of angularities would therefore be within the spirit and scope of the invention.

It can also be seen from the foregoing that many advantages are accomplished by the joining system 10 for tubular members of the present invention. Stabilizing members 14 and 28 have been provided which are members having grooves 27 on the top 22 or 25 and bottom surface 24 or 26 to form the seat for holding a tubular member 12 at one of a plurality of angularities relative to another tubular member 12. Two types and different sizes of wing nut 45 and petcock wrenches 82 have also been disclosed.

Two types of jig systems 108 and 142 for holding a tubular member 12 in place while a hole 31 is drilled therethrough have also been disclosed. A method of joining tubular members to each other has also been disclosed whereby a stabilizing member 14 or 28 is used to attach one tubular member 12 to a second tubular member 12 at a desired angle.

While there has been accomplished advantages by the Applicant's invention, nevertheless, variation in the structure of the invention and arrangement of the various parts are within the spirit and scope of the Applicant's invention. The embodiments given have been given only by way of illustration and the Applicant is not to be limited to the embodiments shown and described.

Having described my invention, I claim:

1-19. (canceled)

20. A structure comprising:
at least a first tubular member and a second tubular member;
at least one stabilizing member disposed between the first and second tubular members, the stabilizing member having first and second opposing surfaces, the first surface having a plurality of circumferentially arrayed concave, tubular-member-engaging grooves, each groove in the first surface being diametrically opposed to another groove in the first surface, the first tubular member being disposed in and extending through only two diametrically opposed grooves of the plurality of grooves in the first surface, the second surface having a plurality of circumferentially arrayed concave, tubular-member-engaging grooves, each groove in the second surface being diametrically opposed to another groove in the second surface, the second tubular member being disposed in and extending through only two diametrically opposed grooves of the plurality of grooves in the second surface; and
at least one attaching member configured to secure the tubular members to the stabilizing member.

21. The structure of claim 20, wherein the first and second tubular members are arranged in a criss-cross relationship relative to each other.

22. The structure of claim 20, wherein each of the first and second tubular members having cylindrical outer surfaces, and the grooves of the first and second surfaces of the stabilizer member are shaped to engage the cylindrical outer surfaces of the first and second tubular members, respectively.
